(19) United States
(12) Patent Application Publication
(10) Pub. No.: US 2010/0096971 A1
(43) Pub. Date: Apr. 22, 2010

(54) Oxidation resistant base of compact fluorescent lamp

(76) Inventors: Chia-Chieh Liu, Taichung (TW); Chun-Wei Liu, Taichung (TW)

Correspondence Address: SAM CHEN, 7F-1, 293, ROOSEVELT ROAD, SEC 3, TAIPEI, TW

(21) Appl. No.: 12/254,015

(22) Filed: Oct. 20, 2008

(51) Int. Cl. H01J 5/50

(52) U.S. Cl. 313/318.04

(57) ABSTRACT

A compact fluorescent lamp includes a base comprising a first conductive advancing spiral ridge, a surface opening, and an insulative internal bossed hole open to the bottom; an electronic ballast on the base and comprising a PCB; a first conductive member securely fitted in the opening and comprising an inner first stem and a complementary second conductive advancing spiral ridge; a second conductive member comprising an electrical contact on one end fitted in the mouth of the bossed hole, and a second stem passing through the bossed hole to be spaced from the first stem; a top bulb electrically connected to the PCB; first and second conductors for electrically interconnecting the PCB and the first and second stems; and a support comprising two through holes securely put on upper portions of the first and second stems and the exposed ends of the conductors.

### BACKGROUND OF THE INVENTION

1. Field of Invention

The invention relates to compact fluorescent lamps (CFLs) and more particularly to such a CFL having an oxidation resistant base and other improved characteristics.

2. Description of Related Art

Incandescent lamps are gradually phased out due to high energy consumption. In recent decades, CFLs are becoming more popular because they are more energy-efficient.

However, screw bases of conventional CFLs tend to get rusted due to oxidation. Hence, it is often that a person may exert a great force to detach the base of a CFL from an electrical socket for, for example, replacement. To the worse, the removal may be impossible if the base and the socket are stuck together due to serious rust.

Electroplating of the screw base may solve the problem. However, its manufacturing cost is high and electroplating may further cause pollution to the environment in the manufacturing process. Thus, the need for improvement still exists.

### SUMMARY OF THE INVENTION

It is therefore one object of the invention to provide an oxidation resistant base of a compact fluorescent lamp.

The above and other objects, features and advantages of the invention will become apparent from the following detailed description taken with the accompanying drawings.

### BRIEF DESCRIPTION OF THE DRAWINGS

FIG. 1 is a side elevation of a first preferred embodiment of compact fluorescent lamp according to the invention;

FIG. 2 is an exploded perspective view of the base and the electronic ballast of FIG. 1;

FIG. 3 is a side elevation in part section of the compact fluorescent lamp;

FIG. 4 is an exploded perspective view of base and electronic ballast of a second preferred embodiment of compact fluorescent lamp according to the invention; and

FIG. 5 is a side elevation in part section of the assembled compact fluorescent lamp of FIG. 4.

### DETAILED DESCRIPTION OF THE INVENTION

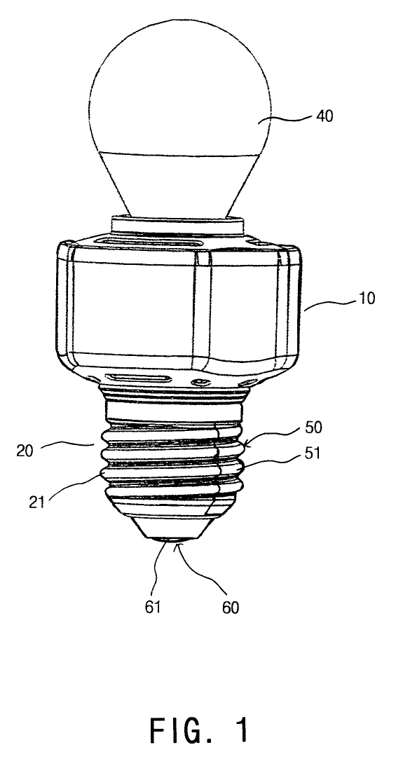

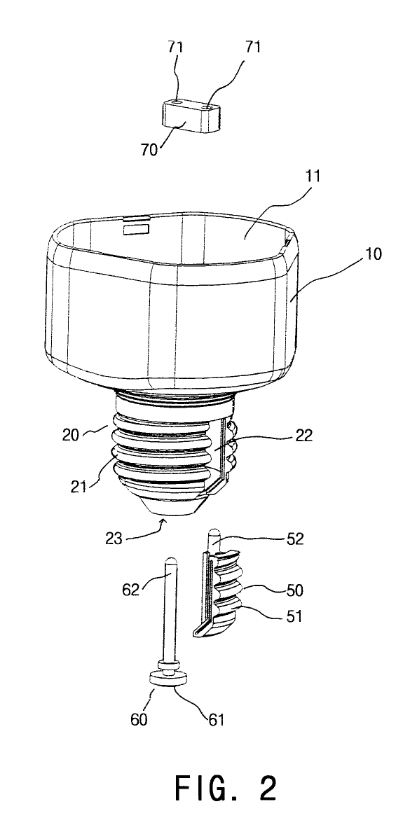

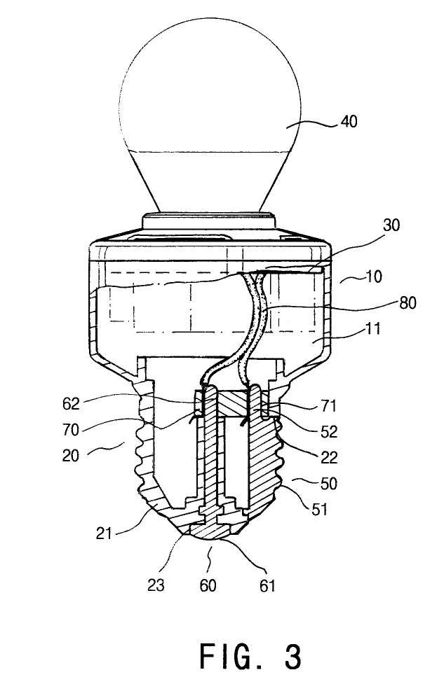

Referring to FIGS. 1 to 3, a compact fluorescent lamp (CFL) in accordance with a first preferred embodiment of the invention is shown. The CFL comprises the following components as discussed in detail below.

A hollow, cylindrical screw base 20 comprises a conductive advancing spiral ridge 21, a substantially rectangular opening 22 on the circumferential surface, and an internal bossed hole 23 open to the bottom. The bossed hole 23 is formed of insulative material.

An intermediate electronic ballast 10 is formed integrally with the base 20. A small printed circuit board (PCB) 30 is provided in an internal space 11 of the electronic ballast 10.

A first conductive member 50 is shaped to securely fit in the opening 22. The first conductive member 50 comprises a conductive advancing spiral ridge 51 and an inner stem 52. The first conductive member 50 and the base 20 together form a complete conductive advancing spiral ridge of the base of a typical CFL.

A pin shaped second conductive member 60 comprises an electrical contact 61 on the head fitted in the mouth of the bossed hole 23, and a stem 62 snugly passing through the bossed hole 23 to be substantially flush with the stem 52.

A bulb 40 is provided on the top of the electronic ballast 10 and is electrically connected to the PCB 30. The PCB 30 is in turn electrically connected to the stems 52, 62 via conductors 80.

A support 70 of substantially rectangular body comprises two parallel longitudinal through holes 71 which are sized to securely put on upper portions of the stems 52, 62 and the exposed ends of the conductors 80. Hence, the support 70 is fastened to make the electrical connection of the conductors 80 and the stems 52, 62 to be secure and reliable. As a result, a complete circuit is constructed with electrical power being adapted to apply through the second conductive member 60, one conductor 80, the PCB 30, the bulb 40, the PCB 30, the other conductor 80, and the first conductive member 50.

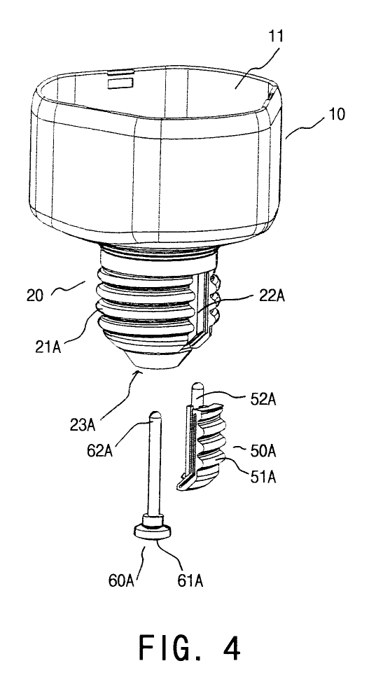

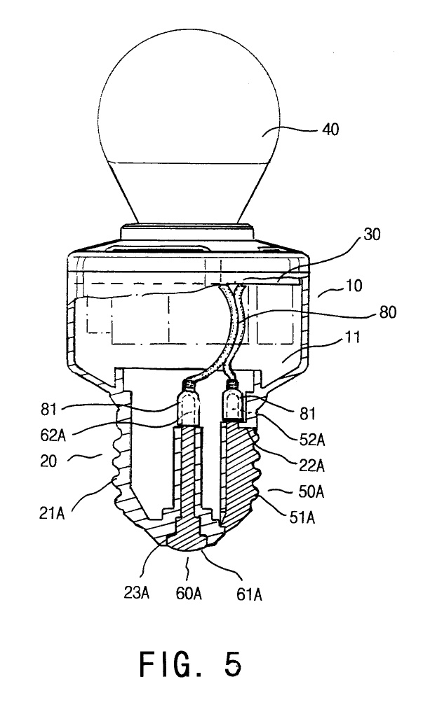

Referring to FIGS. 4 and 5, a CFL in accordance with a second preferred embodiment of the invention is shown. The characteristics of the second preferred embodiment are detailed below. The CFL comprises the following components as discussed in detail below.

A hollow, cylindrical screw base 20 comprises a conductive advancing spiral ridge 21A, a substantially rectangular opening 22A on the circumferential surface, and an internal bossed hole 23A open to the bottom. The bossed hole 23A is formed of insulative material.

An intermediate electronic ballast 10 is formed integrally with the base 20. A small printed circuit board (PCB) 30 is provided in an internal space 11 of the electronic ballast 10.

A first conductive member 50A is shaped to securely fit in the opening 22A. The first conductive member 50A comprises a conductive advancing spiral ridge 51A and an inner stem 52A. The first conductive member 50A and the base 20 together form a complete conductive advancing spiral ridge of the base of a typical CFL.

A pin shaped second conductive member 60A comprises an electrical contact 61A on the head fitted in the mouth of the bossed hole 23A, and a stem 62A snugly passing through the bossed hole 23A to be substantially flush with the stem 52A.

A bulb 40 is provided on the top of the electronic ballast 10 and is electrically connected to the PCB 30. The PCB 30 is in turn electrically connected to two conductors 80. Each of the conductors 80 has a conductive sheath 81 at one end. The sheaths 81 are adapted to securely fit on the exposed upper portions of the stems 52A, 62A to electrically connect thereto. As a result, a complete circuit is constructed with electrical power being adapted to apply through the second conductive member 60A, one conductor 80, the PCB 30, the bulb 40, the PCB 30, the other conductor 80, and the first conductive member 50A.

An oxidation resistant base of a CFL can be obtained by either embodiment of the invention.

While the invention herein disclosed has been described by means of specific embodiments, numerous modifications and variations could be made thereto by those skilled in the art without departing from the scope and spirit of the invention set forth in the claims.

What is claimed is:

1. A compact fluorescent lamp comprising:
a substantially hollow, cylindrical base comprising a first conductive advancing spiral ridge, an opening on the circumferential surface, and an internal bossed hole open to the bottom, the bossed hole being formed of insulative material;
an electronic ballast disposed on the base and comprising a printed circuit board (PCB) disposed therein;
a first conductive member shaped to securely fit in the opening, the first conductive member comprising an inner first stem and a second conductive advancing spiral ridge together with the first conductive advancing spiral ridge to form a complete conductive advancing spiral ridge;
a second conductive member comprising an electrical contact on one end fitted in the mouth of the bossed hole, and a second stem passing through the bossed hole to be spaced from the first stem;
a bulb fitted on the electronic ballast and electrically connected to the PCB;
first and second conductors for electrically interconnecting the PCB and the first and second stems; and
a support comprising two through holes adapted to securely put on upper portions of the first and second stems and the exposed ends of the conductors.

2. A compact fluorescent lamp comprising:
a substantially hollow, cylindrical base comprising a first conductive advancing spiral ridge, an opening on the circumferential surface, and an internal bossed hole open to the bottom, the bossed hole being formed of insulative material;
an electronic ballast disposed on the base and comprising a printed circuit board (PCB) disposed therein;
a first conductive member shaped to securely fit in the opening, the first conductive member comprising an inner first stem and a second conductive advancing spiral ridge together with the first conductive advancing spiral ridge to form a complete conductive advancing spiral ridge;
a second conductive member comprising an electrical contact on one end fitted in the mouth of the bossed hole, and a second stem passing through the bossed hole to be spaced from the first stem;
a bulb fitted on the electronic ballast and electrically connected to the PCB; and
first and second conductors each comprising a sheath at one end, the sheaths being adapted to securely fit on upper portions of the first and second stems to electrically interconnect the PCB and the first and second stems.
